(19) United States
(12) Patent Application Publication
(10) Pub. No.: US 2010/0084972 A1
(43) Pub. Date: Apr. 8, 2010

(54) High-Efficiency Light Bulb

(76) Inventor: Shaam Sundhar, Princeton, NJ (US)

Correspondence Address: PATWRITE LLC, 408 W. MAIN ST., MARSHALLTOWN, IA, 50158-5759, US

(21) Appl. No.: 12/245,930

(22) Filed: Oct. 6, 2008

(51) Int. Cl. H01K 1/50

(52) U.S. Cl. 313/578

(57) ABSTRACT

A lightbulb comprising a base and a selectively detachable bulb means is disclosed. The base has an enclosure with a socket means, a base connector means, and a circuit means for conveying electric power from the socket means to the connector means. The bulb means has a bulb connector means that is mechanically and electrically cooperative with the base connector means to secure the bulb means to the base and conduct electrical power therethrough. The bulb means further includes a glass bulb that is fixed to the bulb connector means and encloses a non-opaque, substantially hollow capsule that includes within a filament. The capsule further has a non-reactive gas sealed therein.

### CROSS-REFERENCE TO RELATED APPLICATIONS

Not Applicable.

### STATEMENT REGARDING FEDERALLY SPONSORED RESEARCH AND DEVELOPMENT

Not Applicable.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### FIELD OF THE INVENTION

This invention relates to light bulbs, and more particularly to an improved efficiency light bulb.

### DISCUSSION OF RELATED ART

Regular house-hold incandescent bulbs are still the primary source of electrical illumination. General Electric alone manufactures 2.1 billion new light bulbs per year at their Ohio factory. Compact Fluorescent Lamps (CFL) have only penetrated about 5% of residential market (L.R.C., New York). The reasons why market penetration of CFL are simple: the color rendition (spectrum) of CFL is not as “cheerful” lighting as incandescent. Consumers tend to equate CFL illumination with the unappealing office look of fluorescent lighting, and most of CFLs cannot be dimmed. Also the color reflection from skin tends to give people a pale look. Further, CFLs contain environmentally hazardous materials such as mercury. As such, incandescent bulbs remain popular.

Color rendition and so-called “warm” light from regular incandescent bulb is more appealing to most consumers. In addition, a quality CFL costs several times more than an incandescent bulb. Further, most CFLs cannot be used in cold environments, such as outside or in garages, since they typically have a relatively high minimum operating temperature.

However, CFLs are not without certain advantages. For example, a quality CFL may last up to 8,000 hours and often is more efficient in converting electricity into light (typically, 40 Lumens per Watt). While a regular incandescent bulb may cost a fraction of a quality CFL, its efficiency is considerably less. With a typical incandescent bulb, more than 95% of energy input is converted to heat and less than 5% is converted to light (10 to 12 Lumens per Watt). Also incandescent bulbs have a relatively short average life of about 1,000 hours. Frequent bulb changing can be quite annoying and expensive.

Low voltage lamps, such as 12 volt lamps, have higher efficiency (Lumens per Watt) compared to higher voltage bulbs, such as those that run at 120 Volts. This is due to the fact that for the same power (Watts), which is the product of voltage (Volts) and current (Amperes), the lower voltage bulb necessarily has higher current for comparable power bulbs. The higher the current, the higher the light out put.

The light output of a filament is directly proportional to its burning temperature. The greater the temperature, the more light energy that is emitted. In a regular incandescent or halogen lamp, most of the heat generated escapes through the glass envelope of the bulb. If the glass envelope retains the heat instead of letting it escape, then a portion of that energy is reutilized by increasing the temperature of the filament. This causes an increase in the light output. For example, an Infrared coating applied to the glass envelope passes visible light through the glass envelope but prevents some of the heat from escaping. Such an IR coating reflects back a portion of the filament heat, and thus such an IR coating on the glass envelop increases the efficiency of the bulb.

Heavy non-reactive gases such as Xenon, Krypton, and Bromine can further impede tungsten molecules from “boiling off” of a bulb filament at high temperature. As such, a tungsten filament can retain its mass for a longer period of time, increasing the life of the bulb.

Further, if a tungsten filament lamp is operated at a lower voltage than its designed voltage, the life of such lamp is exponentially increased. Specifically, the average life of a bulb can be increased from 4,000 hours to 40,000 hours if it is operated at 9 volts when its design voltage is 12 V.

A transparent silicone coating, having a high insulation “R” value, may further be used on the outer glass envelope of a bulb. As such, heat does not as easily pass through a silicone coating as it does with glass alone. A bulb with such a coating is relatively cool to the touch. Additionally, such a silicone coating may be used between the filament and any electronic components of such a bulb, and lowering the temperature of the electronic components of the bulb extends the average life thereof.

Therefore, there is a need for a device that incorporates the beneficial properties of both CFL and incandescent bulbs, while minimizing those qualities of each type that are detrimental. Such a needed device would have no mercury, would be twice as efficient as an incandescent bulb, have an average life of at least four times an incandescent bulb, but would have a color rendition similar thereto. Such a needed device would be more efficient than an incandescent bulb, providing at least 12 but preferably 24 lumens per watt. Further, such a needed device would provide a replaceable bulb portion selectively detachable from a base that includes ballast electronics. The present invention accomplishes these objectives.

### SUMMARY OF THE INVENTION

The present device is a lightbulb comprising a base and a selectively detachable bulb means. The base has an enclosure with a socket means at a lower end thereof The base includes a base connector means at an upper end thereof, and the enclosure houses a circuit means for conveying electric power from the socket means to the connector means.

The bulb means has a bulb connector means that is mechanically and electrically cooperative with the base connector means to secure the bulb means to the base and conduct electrical power therethrough. The bulb means further includes a glass bulb that is fixed to the bulb connector means and encloses a non-opaque, substantially hollow capsule that includes within a filament. The capsule further has a non-reactive gas sealed therein.

In one embodiment of the invention, the base connector means includes a pair of arched keyhole slots in a top surface of the enclosure. The bulb connector means of the bulb means is a cooperating pair of T-shaped conductors, such that the conductors may be inserted into the keyhole slots, the bulb means twisted with respect to the base to couple the bulb means with the base both mechanically and electrically.

As such, with the bulb means coupled to the base and with power applied to the socket means, electrical power flows through the socket means, each connector means, the lead wires, and the filament to light the lightbulb.

The present invention is a lightbulb that incorporates many of the beneficial properties of both CFL and incandescent bulbs, while minimizing those qualities of each type that are detrimental. The present device contains no mercury, is twice as efficient as an incandescent bulb, has an average life of at least four times an incandescent bulb, but has a color rendition or spectrum similar to that of daylight. The present lightbulb is more efficient than an incandescent bulb, providing at least 12 but as high as 24 lumens per watt. Further, such a device provides a replaceable bulb portion selectively detachable from a base that includes ballast electronics, thereby reducing costs when a replacement bulb is needed. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is an exploded perspective view of a light bulb of the present invention;

FIG. 2 is a front elevational view thereof;

FIG. 3 is a front elevation view of an incandescent capsule of the invention;

FIG. 4 is an electronic schematic diagram of one embodiment of the invention;

FIG. 5 is an exploded perspective view of an alternate embodiment of the base of the present invention; and

FIG. 6 is a cut-away perspective view of the base of FIG. 5, showing a circuit means of the invention therein.

### DETAILED DESCRIPTION OF THE PREFERRED EMBODIMENT

Illustrative embodiments of the high-efficiency light bulb are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

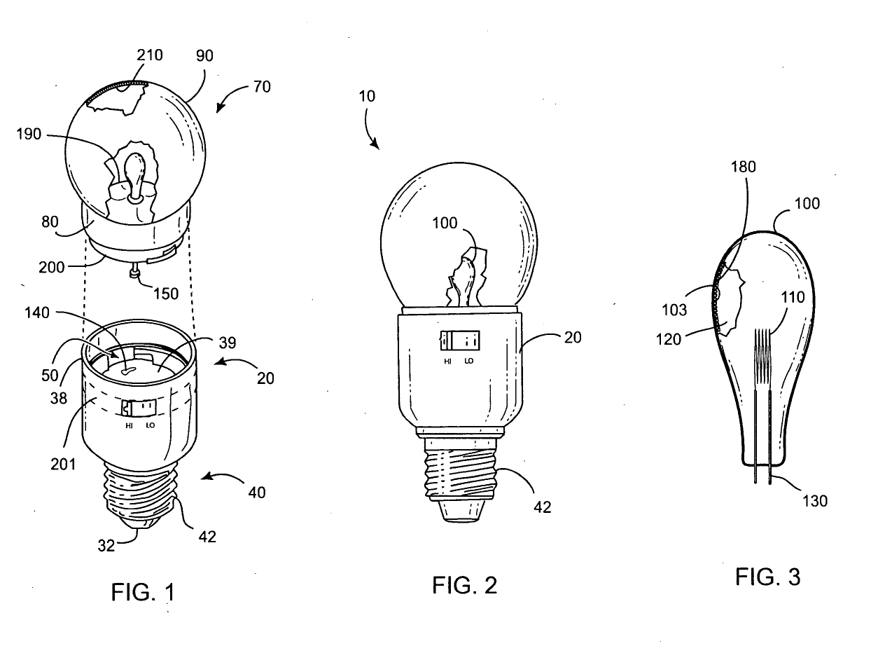

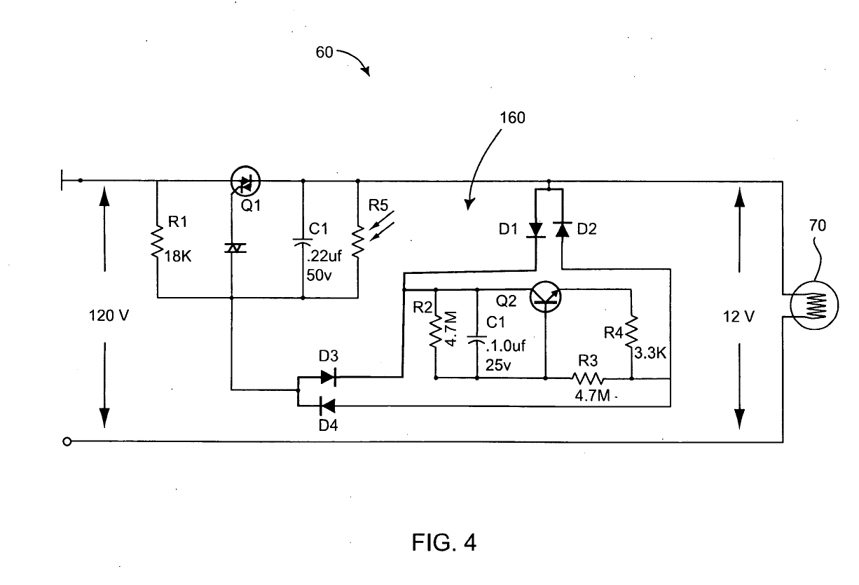

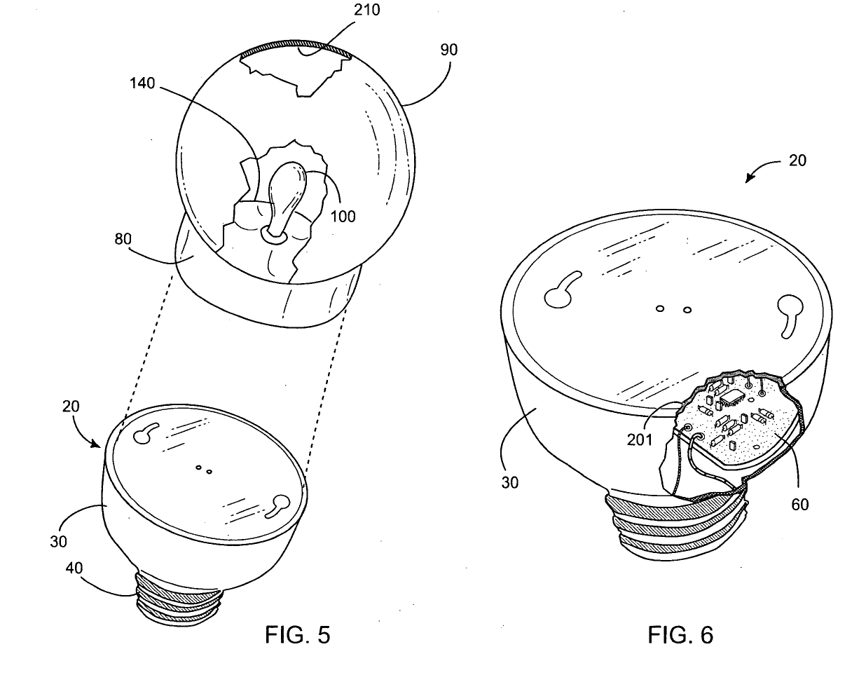

FIGS. 1 and 2 illustrate a lightbulb 10 comprising a base 20 and a selectively detachable bulb means 70. The base 20 has an enclosure 30 with a socket means 40 at a lower end 32 thereof. The base 20 includes a base connector means 50 at an upper end 38 thereof, and the enclosure 30 houses a circuit means 60 (FIGS. 4 and 6) for conveying electric power from the socket means 40 to the connector means 50. In one embodiment, the circuit means 60 is a circuit board that includes a voltage step-down transformer 160, which may be a two-step transformer (not shown) that is selectively set to one of two output voltages, such as 9V and 12V, with a manually-actuable switch 170 on the base enclosure 30 (FIGS. 1 and 2). As such, the two output voltages correspond to a “dim” and a “bright” setting for light intensity of the lightbulb 10.

The socket means 40 is preferably a screw-type cap 42 for placement in a standard screw style electrical socket (not shown). Alternately the socket means 40 is a bayonet-type cap for placement in a bayonet-style electrical socket, as is known in the art.

The bulb means 70 (FIG. 3) has a bulb connector means 80 that is mechanically and electrically cooperative with the base connector means 50 to secure the bulb means 70 to the base 20 and conduct electrical power therethrough. The bulb means 70 further includes a glass bulb 90 that is fixed to the bulb connector means 50 and encloses a non-opaque, substantially hollow capsule 100, made from a quartz material, for example, that includes within a filament 110, such as a fortified tungsten filament. The capsule 100 further has a non-reactive gas 120 sealed therein, such as a mixture of any or all of Krypton, Bromine, or Xenon, for example. A pair of lead wires 130 traverse the capsule 100 and are electrically connected to the bulb connector means 80. Each connector means 50, 80 may further include a heat insulator 200, 201, respectively, such as a silicone material or the like, for insulating the base 20 from heat generated by the filament 110. Further, the glass bulb 90 may further include a substantially transparent silicone coating 210 applied to an inside surface 93 thereof, such that a portion of the heat energy produced by the filament 110 is retained within the glass bulb 90.

In one embodiment of the invention, a reflector element 190 may be mounted inside the glass bulb 90 (FIG. 1) to reflect light directed towards the base 20 away form the base 20. Further, preferably the non-opaque capsule 100 includes an infrared coating 180 applied to an inside surface 103 thereof (FIG. 3). As such, a portion of the infrared energy produced by the filament 110 is reflected back onto the filament 110.

In one embodiment of the invention, the base connector means 50 includes a pair of arched keyhole slots 140 in a top surface 39 of the enclosure 30. The bulb connector means 80 of the bulb means 70 is a cooperating pair of T-shaped conductors 150, such that the conductors 150 may be inserted into the keyhole slots 140, the bulb means 70 twisted with respect to the base 20 to couple the bulb means 70 with the base 20 both mechanically and electrically.

As such, with the bulb means 70 coupled to the base 20 and with power applied to the socket means 40, electrical power flows through the socket means 40, each connector means 80, the lead wires 130, and the filament 110 to light the lightbulb 10.

While a particular form of the invention has been illustrated and described, it will be apparent that various modifications can be made without departing from the spirit and scope of the invention. For example, the styles of socket means 40 may be any suitable socket type as is known in the art. Accordingly, it is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in its implementation details, while still being encompassed by the invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A lightbulb comprising:
a base having an enclosure with a socket means at a lower end thereof and a base connector means at an upper end thereof, the enclosure including a circuit means mounted therein for conveying electric power from the socket means to the connector means; and
a selectively detachable bulb means having a bulb connector means mechanically and electrically cooperative with the base connector means to secure the bulb means to the base and conduct electrical power therethrough, the bulb means further including a glass bulb fixed to the bulb connector means and enclosing a non-opaque, substantially hollow capsule that includes within a filament and a non-reactive gas sealed therein, a pair of lead wires traversing the capsule and electrically connected to the bulb connector means;
whereby with the bulb means coupled to the base and power applied to the socket means, electrical power flows through the socket means, each connector means, the lead wires, and the filament to light the lightbulb.

2. The lightbulb of claim 1 wherein the socket means is a screw-type cap for placement in a screw style electrical socket.

3. The lightbulb of claim 1 wherein the socket means is a bayonet-type cap for placement in a bayonet-style electrical socket.

4. The lightbulb of claim 1 wherein the base connector means includes a pair of arched keyhole slots in a top surface of the enclosure, and wherein the bulb connector means is a pair of T-shaped conductors, whereby the conductors may be inserted into keyhole slots, the bulb means then twisted with respect to the base to couple the bulb means with the base both mechanically and electrically.

5. The lightbulb of claim 1 wherein the circuit means includes an electric voltage step-down transformer.

6. The lightbulb of claim 5 wherein the voltage step-down transformer is a two-step transformer that is selectively set two one of two output voltages with a manually-actuable switch on the base enclosure.

7. The lightbulb of claim 6 wherein the two selectable output voltages are 9V and 12V.

8. The lightbulb of claim 1 wherein the non-opaque capsule includes an infrared coating applied to an inside surface thereof, such that a portion of the infrared energy produced by the filament is reflected back onto the filament.

9. The lightbulb of claim 1 wherein a reflector element is mounted inside the glass bulb to reflect light directed towards the base away from the base.

10. The lightbulb of claim 1 wherein each connector means further includes a heat insulator.

11. The lightbulb of claim 10 wherein the heat insulator is a silicone material.

12. The lightbulb of claim 1 wherein the glass bulb includes a substantially transparent silicone coating applied to the inside surface thereof, such that a portion of the heat energy produced by the filament is retained within the glass bulb.

13. The lightbulb of claim 1 wherein the non-reactive gas is a mixture taken from the set of gases consisting of: Krypton, Bromine, and Xenon.

14. The lightbulb of claim 1 wherein the capsule is made from a substantially transparent quartz material.

15. The lightbulb of claim 1 wherein the filament is a fortified tungsten filament.
